(19) United States
(12) Patent Application Publication
(10) Pub. No.: US 2002/0101520 A1
(43) Pub. Date: Aug. 1, 2002

(54) Method and apparatus for upgrading legacy optical imaging systems with digital image capture and management

(76) Inventor: William Milam, Yucaipa, CA (US)

Correspondence Address: Jack I. J'maev, 12616 Lewis Ave, Chino, CA, 91710, US

(21) Appl. No.: 10/023,494

(22) Filed: Dec. 17, 2001

Related U.S. Application Data
(60) Provisional application No. 60/256,684, filed on Dec. 18, 2000.

(51) Int. Cl. H04N 5/76

(52) U.S. Cl. 348/232; 348/375; 348/64

(57) ABSTRACT

Method and apparatus for upgrading imaging systems to accommodate replacement cameras. Replacement camera may be film-based or digital. Computing device with specialized software manages image acquisition. Parametric data, date, time and location of image acquisition may all be stored with image on computer readable media.

### RELATED APPLICATIONS

This present application is related to a provisional application serial number 601256,684 filed on Dec. 18, 2000, entitled “DIGITAL CAPTURE UPGRADE APPARATUS AND METHOD FOR IMAGING EQUIPMENT” invented by William Milam, Jr. et al., currently pending, for which the priority date for this application is hereby claimed.

### BACKGROUND OF THE INVENTION

1. Technical Field

This invention pertains to the field of imaging equipment. Specifically, this invention pertains to methods and apparatus supporting the upgrade of imaging systems to allow use of a replacement camera.

2. Description of the Prior Art

Many and varied imaging systems are currently known. Most of these systems include sophisticated optical assemblages, each tailored to meet the functional requirements of a particular use. Many industries and professions use specialized imaging systems. One such profession is the medical profession. Medical imaging systems have generally been integrated with specialized photographic equipment that is tailored to meet the specialized needs of particular applications. The specialized photographic equipment rarely conformed to any standards otherwise promulgated in consumer or industrial applications. This rendered the entire medical imaging apparatus, comprised of an optical assemblage and a photographic element, to be entirely unique. This, of course, results in the need for specialized logistical support for the apparatus. When any particular component failed, only the original manufacturer would likely be capable of supplying replacement parts.

The photographic element used in known medical imaging systems is the one component most susceptible to failure. Generally, the photographic element in a medical imaging system comprises a camera. The cameras used by each manufacturer are usually specific to the imaging systems they build and do not conform to industry standards. One purpose for this lack of conformity is simply a financial motive on the part of imaging system manufacturers. By using custom cameras, imaging system manufacturers can force their customers to return for service, repair or replacement of the application specific camera. A second purpose for the use of custom cameras was in fact, functional. In many cases, the optical assemblages used to collect and process application specific images required extended or irregular exposure means.

The cost incurred in purchasing a specialized imaging system has always been significant, due mostly to the custom nature of the equipment and the limited number of units produced. And only a few customers demand such high-priced equipment. Hence, the demand for specialized imaging systems is extremely limited. The combination of limited demand and high price has limited the number of manufacturers, resulting in an oligopoly.

The oligopolistic nature of the specialized imaging system marketplace has left the industry in a state where new innovations are slow to develop and are typically extremely expensive. As one example, consider a typical medical imaging system. Many prior art film based apparatus have been displaced by new digital imaging systems. However, the new digital imaging systems have been slow to market and are again proprietary in nature. In medical imaging systems, manufacturers have again failed to adopt industry norms in order to force system users to return to the original manufacturer, or its authorized agents for repair and/or service.

One even more discouraging manifestation of the prior art digital imaging systems is that the manufacturers that comprise the oligopoly have chosen to implement video based digital capture. This format, although easy to integrate into existing optical assemblages, fails to provide the resolution previously attainable by earlier film based cameras. Hence, the peculiar nature of the specialized imaging systems marketplace has caused a depreciating quality in the overall product.

These factors have left institutions, which are the most prevalent users of medical imaging instruments, in somewhat of a quandary. The motive to update to a digital imaging system is clearly present in the industry, but to do so required high capital investment. And adding insult to injury, the resolution offered by the video based systems is far inferior to that obtainable with the film based imaging systems currently in use. In many case, medical imaging system users cannot justify the expense of upgrading to a digital solution, especially in light of inferior photographic resolution. As a result, the existing legacy systems continue in service. Of course, this same result is found in other specialized imaging systems that are used in various industries.

What is needed then, is a means to upgrade specialized imaging instruments so that replacement film cameras or digital cameras may be used. Where digital cameras are used, digital images should be captured with high resolution. From the financial perspective any such means should take advantage of any legacy equipment that users are currently operating. The present invention addresses both of these issues by providing a method of adapting a modern film or digital camera to a legacy optical assemblage used in specialized imaging systems.

### SUMMARY OF THE INVENTION

The present invention comprises both a method for upgrading legacy optical imaging systems and an upgrade kit that enables the method. Remaining cognizant of the fact that specialized optical imaging systems comprise an optical assemblage and a photographic element, the present invention allows for the continued use of the optical assemblage with a replacement photographic element. The replacement photographic element may typically comprise a camera. In some embodiments of this method, an optical imaging system may be upgraded with a digital camera.

Typically, an existing optical assemblage comprises some form of attachment means that allows an original camera to be coupled to the assemblage. In one example embodiment of a method according to the present invention, upgrade of an imaging system may be achieved by first removing the original camera attachment means from the optical assemblage. Once the original attachment means is removed, a replacement upgrade receptacle may be attached to the optical assemblage.

In this illustrative method, a camera adapter coupling may be used to attach a replacement camera to the optical assemblage. In most embodiments of this method, the camera adapter coupling may comprise a first end that mates with the replacement upgrade receptacle installed on the optical assemblage. The camera adapter coupling may further comprise a second end that emulates a camera lens. This camera-lens-emulating end may be affixed to a replacement camera by installing the lens-emulating end into a lens mount that comprises the replacement camera.

In one variation of this method, the camera used to replace the original film camera in an optical imaging system may comprise a digital camera. In these alternative methods, additional steps may serve to acquire digital images from the digital camera by way of a digital interface. Once the digital images are so acquired, they may be stored on computer readable media for future reference. In yet another refinement of the illustrative method of the present invention, parametric data associative with the digital image may be received in stored together with the image on computer readable media.

In some embodiments of the illustrative method described herein, the date and/or the time that the image was acquired may also be stored on computer readable media. This is especially useful when the time of examination of a particular subject may be relevant. And in an alternative method, the venue of the examination may also be relevant. In such situations, information from a satellite-based or terrestrial positioning system may be acquired and stored together with the digital image on computer readable media.

The present invention also comprises a hardware apparatus comprising an upgrade kit that enables the method of the present invention. According to this illustrative embodiment, an upgrade kit may comprise a replacement coupling receptacle that may be mounted on an optical assemblage. The replacement coupling receptacle will typically accept a camera adapter coupling.

The upgrade kit further comprises a camera adapter coupling. This camera adapter coupling may comprise a first end that mates with the replacement coupling receptacle that is typically installed on the optical assemblage of a specialized imaging system. The camera adapter coupling may also comprise a second end that emulates a camera lens. This lens-emulating end may be fashioned so as to mate with a lens mount integral to a replacement camera.

According to one alternative embodiment of the present invention, the upgrade kit may further comprise a camera. In some alternative embodiments, the camera may be a digital camera. In those embodiments where the camera comprises a digital camera, the upgrade kit may further comprise a general-purpose computing device that comprises computer readable media capable of storing digital images and a digital interface that may be used to connect the computing device to a digital camera. Accordingly, a software program is executed in the general-purpose computing device in order to specialize that device for use in acquiring digital images from the digital camera and storing the images on the computer readable media. Said software program controls the digital interface in order to acquire digital images from the digital camera.

In one alternative embodiment of the upgrade kit, the software program may further comprise a parametric data module. The parametric data module may accept parametric data from a user and may store that parametric data on the computer readable media and may affiliate that data with a particular digital image acquired from the digital camera.

In yet another alternative embodiment of the upgrade kit, the software program may further comprise a date/time data module. The date/time data module may acquire the date and/or the time at which a particular image is captured.

In yet another alternative embodiment, the software program comprising the upgrade kit may further comprise a venue module that accepts position information from a positioning system. The positioning system may be either satellite-based or terrestrial. Whenever an image is captured, the venue module may accept position information and store it together with the acquired image on computer readable media.

According to one alternative embodiment of the method of the present invention, the step of removing an existing camera attachment means may be avoided where a variation to the new camera adapter coupling is introduced. In support of this abbreviated upgrade method, the new camera adapter coupling comprises a first end that may be coupled to an existing camera attachment receptacle installed on an optical assemblage. The second end may comprise a lens-emulating end that may be installed into a lens mount comprising a replacement camera.

### BRIEF DESCRIPTION OF THE DRAWINGS

The foregoing features, aspects, and advantages of the present invention will become better understood from the following detailed description of one embodiment of the invention with reference to the drawings, in which:

FIG. 1 is a pictorial representation of a typical application specific imaging system;

FIG. 2 is a pictorial representation of atypical application specific imaging system that has been upgraded to further comprise a digital capture camera; and

FIG. 3 is a pictorial representation of one example embodiment of a digital imaging system according to the present invention.

### DETAILED DESCRIPTION OF THE INVENTION

The present invention is best described by application of the method and apparatus to a specific medical imaging system. It should be noted, however, that the descriptions proffered here are only a convenient means of describing the invention and are not intended to limit the scope thereof.

One type of imaging instrument that may be upgraded to provide digital capture of an image by the method and apparatus of the present invention is a fundus camera used in ophthalmology. Again, this is merely an example of one type of imaging system and the teachings proffered here are not intended to limit the scope of the present invention. The present invention is applicable to any type of imaging system irrespective of industry or profession or application.

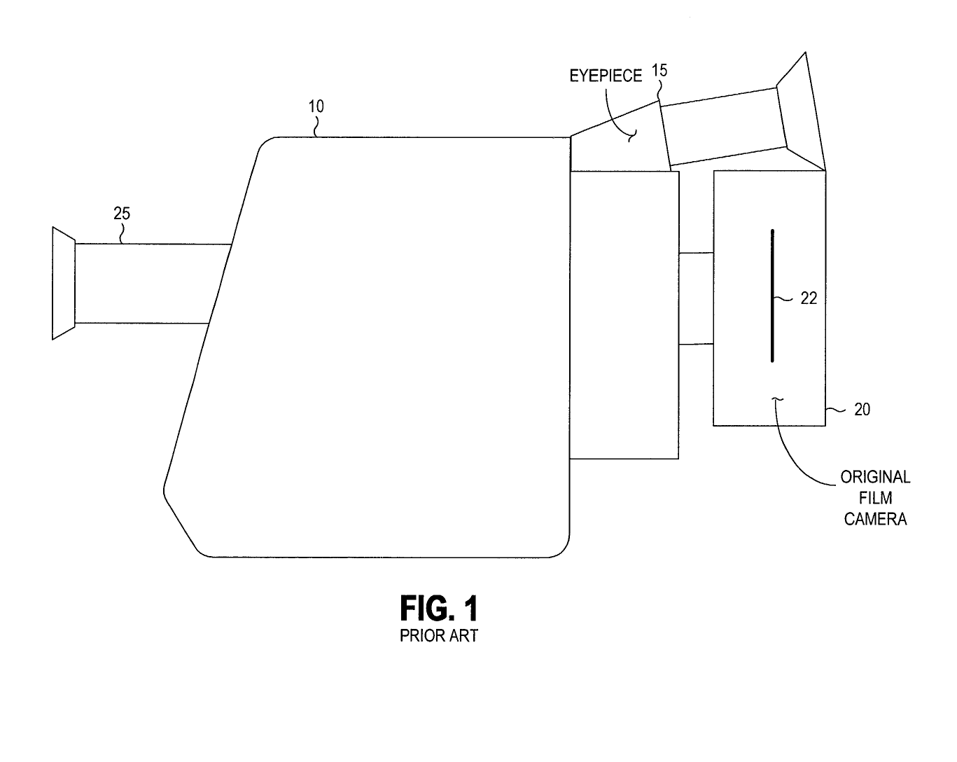

FIG. 1 is a pictorial representation of a typical application specific imaging system. The imaging system itself comprises an optical assemblage 10, an eyepiece 15 and a film capture camera 20. In the prior art, an operative lens 25 receives an image from the subject matter and by way of the optical assemblage 10 propagates the image to a film capture camera 20. The image is focused onto an original film image plane 22 located within the cavity of the film camera.

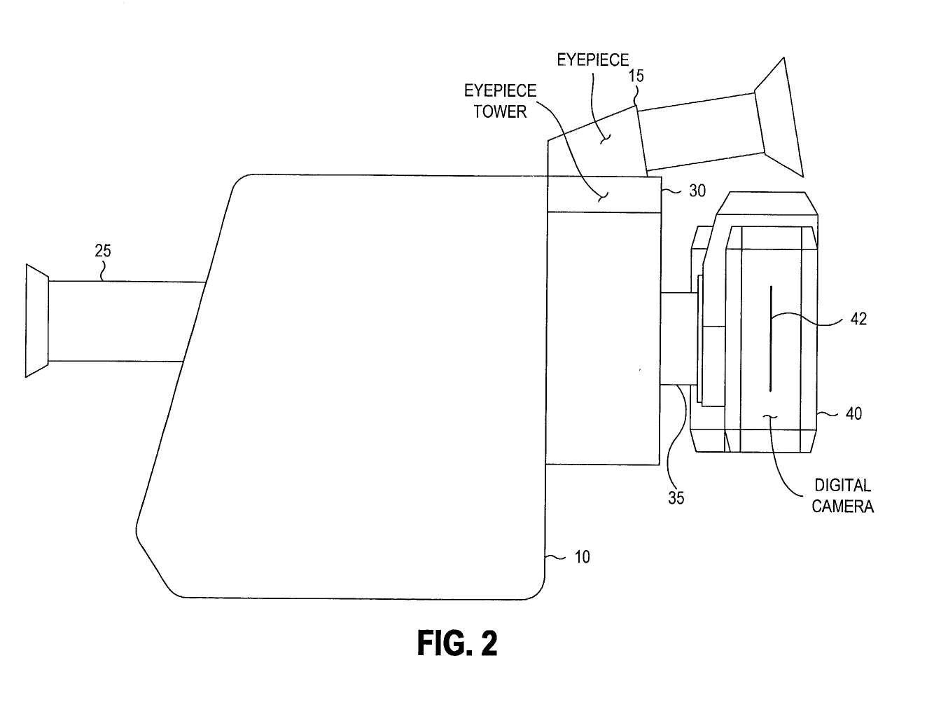

FIG. 2 is a pictorial representation of a typical application specific imaging system that has been upgraded to further comprise a replacement camera. The replacement camera may be either a film camera or a digital camera. In the preferred embodiment of an upgraded imaging system, the operative lens 25 remains unmodified. The eyepiece 15 is also unmodified, but may require relocation by means of an eyepiece tower 30. Such an eyepiece tower may be required if the replacement camera would mechanically interfere with the use of the eyepiece or with the eyepiece itself. An image is directed to replacement camera having a sensitive surface at a replacement image plane 42 located within the cavity of the replacement camera 40.

According to one example method of upgrading a specialized imaging system, an original camera attachment means may be removed from the body of the optical assemblage 10. Once the original attachment means is removed, a new coupling means 35 may be affixed to the optical assemblage 10. This new coupling means enables the attachment of a replacement camera; either film-based or a digital capture camera 40.

In one preferred embodiment of the present invention, a camera adapter coupling 35 comprises a tubular section comprising a first end that mates with the replacement coupling means that may be affixed to the optical assemblage 10. The camera adapter coupling 35 further comprises a second camera attachment end that comprises a lens-emulator. Said lens-emulator may be fashioned to mate with a lens-mount of any particular replacement camera.

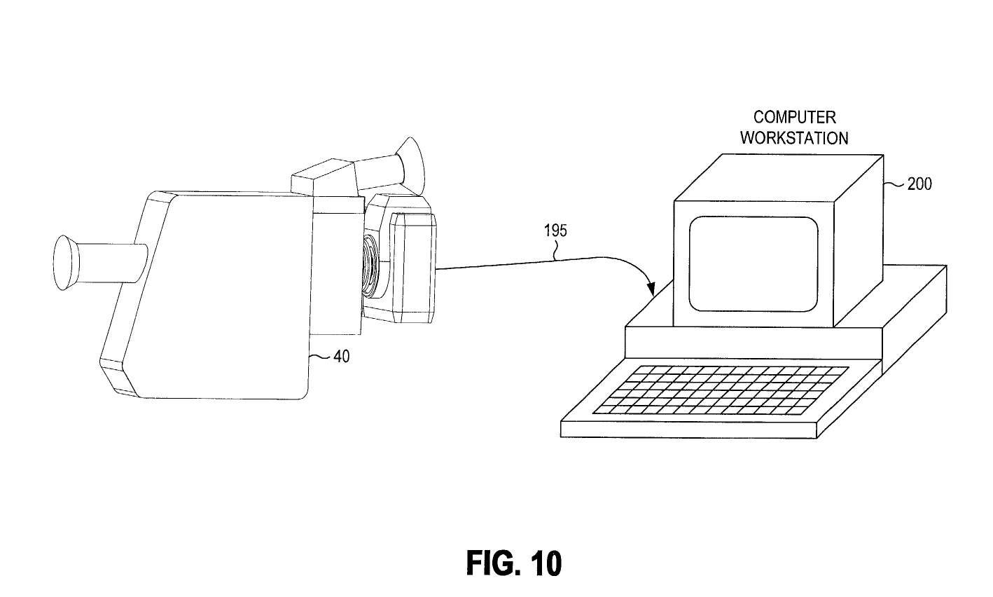

FIG. 3 is a pictorial representation of one example embodiment of a digital imaging system according to the present invention. Once a legacy imaging system is upgraded with a digital camera 40 according to the descriptions set forth herein, a digital interface 195 may be used to acquire digital images from the digital camera 40. The present invention comprises a general purpose computing device 200 that executes special software. The special software converts the general purpose computing device into a specialized image management device. The special software controls the digital interface 195 in order to acquire digital images from the digital camera 40.

The computing device 200 may accept parametric information for each image directly from a system operator using a keyboard or by way of computer readable media. Once an image of the subject matter is acquired by way of the digital interface 195, it may be stored in an image database either alone or together with the parametric information. According to one example embodiment of a software program, a parametric module presents a user interface to a user. Said user interface may be a graphical user interface. According to one illustrative embodiment, a user may use the user interface to enter notations and other parameters that describe the image captured from the digital camera. In the case of a medical application, such information may include, but is not necessarily limited to the name of a patient, age, gender and the like. The form and structure of the parametric information may be varied to accommodate other specialized image capture applications.

The computing device may further comprise a real-time-clock that maintains the date and time of day. In some embodiments, the computing device may obtain time from some other time source such as the global positioning system (GPS) or is a radio-station time beacon. The computing device 200 may also store the date and time the image was acquired by reading the value of the real-time-clock. The date and/or time may be obtained from another time source, such as GPS, and stored in the database along with the image.

In some applications, it may be desirable to record the venue in which the image was acquired. This may have significance in evidentiary support in cases of medical malpractice or accident investigation. In order to record such venue (location) information, the position of a GPS receiver may be stored along with the acquired image in the image database. Any suitable positioning system, either satellite or terrestrially based, may be used as a source for such venue information.

In those embodiments that store parametric information, date, time or venue information, this ancillary information may be stored directly in the image database in separate fields. In one alternative embodiment, ancillary information may be stored in separate databases together with references to the digital images that the ancillary information is associated with.

Alternative Embodiments

While this invention has been described in terms of several preferred embodiments, it is contemplated that alternatives, modifications, permutations, and equivalents thereof will become apparent to those skilled in the art upon a reading of the specification and study of the drawings. It is therefore intended that the true spirit and scope of the present invention include all such alternatives, modifications, permutations, and equivalents. some, but by no means all of the possible alternatives are described herein.

One such alternative that would be obvious after learning of the disclosure presented herein would be the creation of a camera adapter coupling that is capable of mating with the existing attachment means installed on the optical assemblage. Use of such a coupling means would allow upgrade without the removal of the existing attachment means.

I claim:

1. A method for upgrading an imaging system comprising the steps of:
affixing a replacement camera comprising a lens mount to a camera adapter coupling wherein the camera adapter coupling comprises an attachment end and a lens emulating end opposing the upgrade end and wherein the camera is affixed to the camera adapter coupling by mating the lens emulating end with the lens mount; and
mating the attachment end of the camera adapter coupling to the an existing mating receptacle on an optical assemblage.

2. The method of claim 1 wherein the camera is a digital camera.

3. The method of claim 2 further comprising the steps of:
receiving a digital image from the digital camera by way of a digital interface; and
storing the digital image on computer readable media.

4. The method of claim 3 further comprising the steps of:
receiving parametric data associated with the digital image; and
storing the parametric data on computer readable media together with a reference to the digital image.

5. The method of claim 3 further comprising the steps of:
receiving date and/or time data associated with the digital image; and
storing the date and/or time data on computer readable media together with a reference to the digital image.

6. The method of claim 3 further comprising the steps of:
receiving position information from satellite-based or terrestrial positioning system; and
storing the position information on computer readable media together with a reference to the digital image.

7. A method for upgrading an imaging system comprising the steps of:
removing an original camera attachment means from the optical assemblage of an imaging instrument;
attaching an upgrade receptacle to the optical assemblage;
affixing a replacement camera comprising a lens mount to a camera adapter coupling wherein the camera adapter coupling comprises an upgrade end and a lens emulating end opposing the upgrade end and wherein the camera is affixed to the camera adapter coupling by mating the lens emulating end with the lens mount; and
mating the upgrade end of the camera adapter coupling to the upgrade receptacle.

8. The method of claim 7 wherein the camera is a digital camera.

9. The method of claim 8 further comprising the steps of:
receiving a digital image from the digital camera by way of a digital interface; and
storing the digital image on computer readable media.

10. The method of claim 9 further comprising the steps of:
receiving parametric data associated with the digital image; and
storing the parametric data on computer readable media together with a reference to the digital image.

11. The method of claim 9 further comprising the steps of:
receiving date and/or time data associated with the digital image; and
storing the date and/or time data on computer readable media together with a reference to the digital image.

12. The method of claim 9 further comprising the steps of:
receiving position information from satellite-based or terrestrial positioning system; and
storing the position information on computer readable media together with a reference to the digital image.

13. An upgrade kit for imaging systems comprising:
replacement coupling receptacle that mounts on an optical assemblage and accepts a camera adapter coupling; and
camera adapter coupling comprising a first end that mates with the replacement coupling receptacle and a second end being a lens-emulating end.

14. The upgrade kit of claim 13 further comprising a camera.

15. The upgrade kit of claim 14 wherein the camera is a digital camera.

16.The upgrade kit of claim 15 further comprising:
computing device comprising computer readable media for storing digital images;
digital interface that connects the computing device to the digital camera; and
software program that executes in the computing device and controls the digital interface to acquire digital images from the digital camera and store said images on the computer readable media.

17. The upgrade kit of claim 16 wherein the software program further comprises a parametric data module that accepts parametric data from a user and stores the parametric data on the computer readable media together with a reference to a digital images.

18. The upgrade kit of claim 16 wherein the software program further comprises a date/time data module that accepts date and/or time data from a time source and stores the date and/or time data on the computer readable media together with a reference to a digital images.

19.The upgrade kit of claim 16 wherein the software program further comprises a venue module that accepts position information from a positioning system, either satellite-based or terrestrial, and stores the position information on the computer readable media together with a reference to the digital images.
